(19) United States
(12) Patent Application Publication
(10) Pub. No.: US 2004/0145610 A1
(43) Pub. Date: Jul. 29, 2004

(54) Customized wall border imaging solution

(75) Inventors: Charles R. Brown, Lake Zurich, IL (US); Thaddeus H. Kielch III, Roselle, IL (US); Ronnie E. Weeks JR., Hoffman Estates, IL (US)

Correspondence Address: WHYTE HIRSCHBOECK DUDEK S C, 555 EAST WELLS STREET, SUITE 1900, MILWAUKEE, WI, 53202, US

(73) Assignee: VORTX GROUP, Hoffman Estates, IL (US)

(21) Appl. No.: 10/418,507

(22) Filed: Apr. 17, 2003

Related U.S. Application Data
(60) Provisional application No. 60/440,721, filed on Jan. 17, 2003.

(51) Int. Cl. G09G 5/00

(52) U.S. Cl. 345/764

(57) ABSTRACT

Disclosed herein is a method for creating a dynamically-customizable precursor wall border image for display on a graphic user interface (GUI) and capable of use in creating a wall border. The method includes: providing, to a user, access to a plurality of wall border templates from which a user can select one of the plurality of wall border templates for display at the GUI; receiving user input text information, the user input text information viewable at the GUI; receiving user-selected graphic information, the user-selected graphic information viewable at the GUI; and generating, in real time, a precursor wall border image at the GUI, the precursor wall border image having the selected wall border template, the user input text information and the user-selected graphic information. The precursor wall border image is dynamically refreshable to permit changes, if any, to at least one of the selected wall border template, the user input text information and the user-selected graphic information, with masking and graphic effects, to be incorporated into the precursor wall border image and viewable at the GUI in real time by the user. The personalized wall border imaging solution captures and compiles the user's selections and generates on the Internet a visual image of the completed design, as well as a print version for printing the wall border design. The design can then be used to print to a pre-pasted wall border substrate using printing equipment, such as a roll-fed digital press or any roll-fed color imaging device capable of accommodating variable print data. Finishes for the product (glosses, coatings), cutting and rolling are performed in a post-printing process prior to shipping the final product to the customer. The solution provides a customized consumer ready product that allows Internet-based creation and ordering of professionally printed wall border designs.

### CROSS REFERENCE TO RELATED APPLICATION

This application is related to Provisional Application No. 60/440,721 filed with the United States Patent and Trademark Office on Jan. 17, 2003.

### FIELD OF THE INVENTION

This invention relates generally to creating wall borders and more specifically to a solution for creating a dynamically-customizable wall border.

### BACKGROUND OF THE INVENTION

In the remodeling and decorating of rooms, in addition to such traditional painting and wallpaper methods, an increasingly popular decorative option includes the use of wall borders. Wall borders are decorative patterns that are printed to paper, usually in roll form, which are used to enhance the appearance of the wall or other structure to which they are applied.

Traditionally, wall borders are sold “as is”, providing a customer with variety of wall border options or patterns (e.g., striped, floral, colored, or a combination thereof) from which a consumer may select a desired border. In essence, the wall borders that may be purchased tend to be limited to stock supplies. From a customization standpoint, little if any variability or specification of content is permitted, although decisions as to size, shape and color may be available to the consumer.

Increasingly, the use of the Internet has fostered a market for purchasing such traditional wall borders online. Additionally, available in the marketplace are online sources for wall borders that permit some added customization of the wall borders to be married with the personal interests of the consumer.

The basic need for the present invention evolves from the absence of full customization capabilities when creating and/or ordering new wall borders. Specifically, in the online environment, what is lacking is the ability to create a wall border in which images and text can be incorporated and customized to the specific needs of the user or purchaser.

Moreover, in the design process, it has been found that an important feature to online users and/or purchasers of wall borders, and particularly customized wall borders, is to be able to see the in progress or “precursor” wall border as its creation occurs. Such “real-time” customization that occurs with each design element, pattern and the like is currently lacking.

Accordingly, it would be desirable to provide an online wall border creation solution that could provide a customized wall border, and more particularly, a wall border having both customized graphic and text elements. It would further be desirable if such a wall border solution could give access to the user of their work-in-progress or precursor wall border. Preferably, the solution would provide for in real-time view of the precursor wall border so that the user could change or otherwise tailor and customize their wall border to their desired needs, and minimize the time and steps needed to create the customized wall border.

### BRIEF SUMMARY OF THE INVENTION

Disclosed herein is a method for creating a dynamically-customizable precursor wall border image for display on a graphic user interface (GUI) or a digital/electronic device and capable of use in creating a wall border. The method comprises providing, to a user, access to a plurality of wall border templates from which a user can select one of the plurality of wall border templates for display at the GUI; receiving user input text information, the user input text information viewable at the GUI; receiving user-selected graphic information, the user-selected graphic information viewable at the GUI; and generating, in real time, a precursor wall border image at the GUI, the precursor wall border image having the selected wall border template, the user input text information and the user-selected graphic information; wherein the precursor wall border image is dynamically refreshable to permit changes, if any, to at least one of the selected wall border template, the user input text information and the user-selected graphic information to be incorporated into the precursor wall border image and viewable at the GUI in real time by the user.

Also disclosed is a system for creating a dynamically-customizable precursor wall border image for display on a graphic user interface (GUI) and capable of use in creating a wall border. The system comprises means for providing, to a user, access to a plurality of wall border templates from which a user can select one of the plurality of wall border templates for display at the GUI; means for receiving user input text information, the user input text information viewable at the GUI; means for receiving user input graphic information, the user input graphic information viewable at the GUI; and means for generating, in real time, a precursor wall border image at the GUI, the precursor wall border image having the selected wall border template, the user input text information and the user input graphic information; wherein the precursor wall border image is dynamically refreshable to permit changes, if any, to at least one of the selected wall border template, the user input text information and the user input graphic information to be incorporated into the precursor wall border image and viewable at the GUI in real time by the user.

Other aspects, embodiments, alternatives, objects and advantages will become apparent upon a reading of the detailed description that follows.

### BRIEF DESCRIPTION OF THE DRAWINGS

The drawings illustrate the best mode presently contemplated for carrying out the invention.

In the drawings:

FIG. 1 is a schematic illustration of a system for creating a dynamically-customizable precursor wall border image according to one aspect of the present invention;

FIG. 2 is a schematic illustration of another embodiment of a system for creating a dynamically-customizable precursor wall border image;

FIG. 3 is a schematic illustration of a graphic user interface (GUI) showing a template options display screen capture having a plurality of wall border templates from which a user can select one for display at the GUI;

FIG. 4 is a schematic illustration of a GUI showing a selected template screen capture and a precursor wall border image;

FIG. 4a is an example of one embodiment of a precursor wall border image 40;

FIG. 5 is schematic illustration of a GUI showing user input text information screen capture and a precursor wall border image;

FIG. 6 is schematic illustration of a GUI showing a customized user input text information screen capture and a precursor wall border image;

FIG. 6a is an example of the precursor wall border image 40 of FIG. 4a, including personalized text;

FIG. 7 is schematic illustration of a GUI showing a user-selected graphic information screen capture and a precursor wall border image;

FIG. 8 is a schematic illustration of a GUI with a screen capture showing a dynamically-refreshable precursor wall border image;

FIG. 8a is an example of the precursor wall border image of FIGS. 4a and 6a, including personalized graphics;

FIG. 9 is an exemplary process flow chart of a process relating to the present invention;

FIG. 10 is a schematic flow chart illustrating several phases of the present invention.

FIGS. 11a-c illustrate exemplary masked images that can be clipped and incorporated into a wall border as part of one aspect of the present invention; and

FIGS. 11d-g illustrate exemplary stylized framed masked images that can incorporated into a wall border as part of one aspect of the present invention.

### DETAILED DESCRIPTION OF THE INVENTION

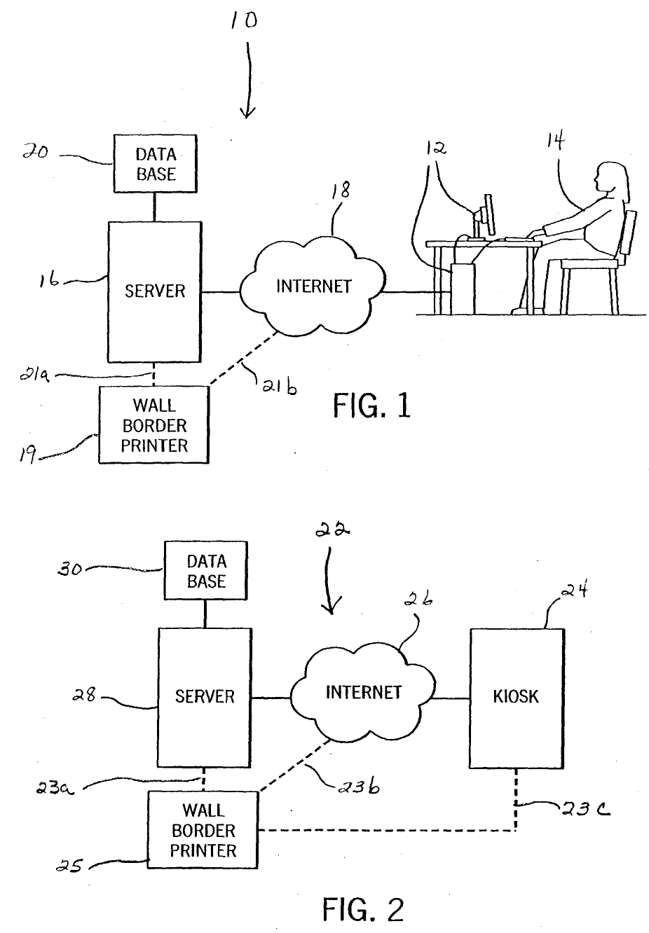

Referring to FIG. 1, a schematic illustration of a system 10 for creating a dynamically-customizable precursor wall border image according to one aspect of the present invention is shown. The system may take any one of a number of forms, and it should be understood that substitution or inclusion of different components is within the scope of the present invention. This embodiment highlights creating a dynamically-customizable precursor wall border image using a computer 12 which can be accessed by a user 14. Computer 12, as shown, is a home computer, however, any computer system (e.g., business-based, retail environment, etc.) can be used. The computer is in electronic communication with server 16 over an Internet 18 (i.e., a computer network, or global computer network). Server 16 is itself in electronic communication with database(s) 20 and the database(s) include all necessary information for creating the precursor wall border image. In operation, user 14 can access a website (e.g., www.mywallborder.com) via computer 12 connected to the Internet 18 to create the desire, dynamically-customizable precursor wall border image.

FIG. 2 is a schematic illustration of another embodiment of a system 22 for creating a dynamically-customizable precursor wall border image. In this embodiment, system 22 includes a kiosk 24 which connects via Internet 26 to server 28 having database(s) 30. In this arrangement, the kiosk is hardwired or is able to “dial up” to the website of interest (i.e., the website for creating the dynamically-customizable precursor wall border image). Alternatively, the kiosk 24 can be a “standalone” unit which is programmed with the information held in database(s) 30 and, along with data supplied or input by a user (not shown) kiosk 24 can be used to create the dynamically-customizable precursor wall border image. The kiosk can be situated in any suitable location. For example, it is contemplated that the kiosk could be located in a home improvement store or at home improvement or repair shows, or at any place in which wall borders may be of interest.

It is contemplated that a wall border printer can be included with either of the systems of FIGS. 1 and 2. In FIG. 1, printer 19 can be connected to server 16 directly via connection 21a or across the Internet via connection 21b, thereby permitting printing of a wall border at a variety of different locations that are either through the website that provides creation of the wall border or via an alternate website connected to the Internet. In FIG. 2, printer 25 can be connected to server 28 directly via connection 23a or across the Internet 23b as before, thereby permitting printing of a wall border at a variety of different locations that are either through the website that provides for creation of the wall border or via an alternate website connected to the Internet. Alternatively, it is contemplated that printing can take place at, or directly from, kiosk 24 via connection 23c to permit a user to create a wall border directly.

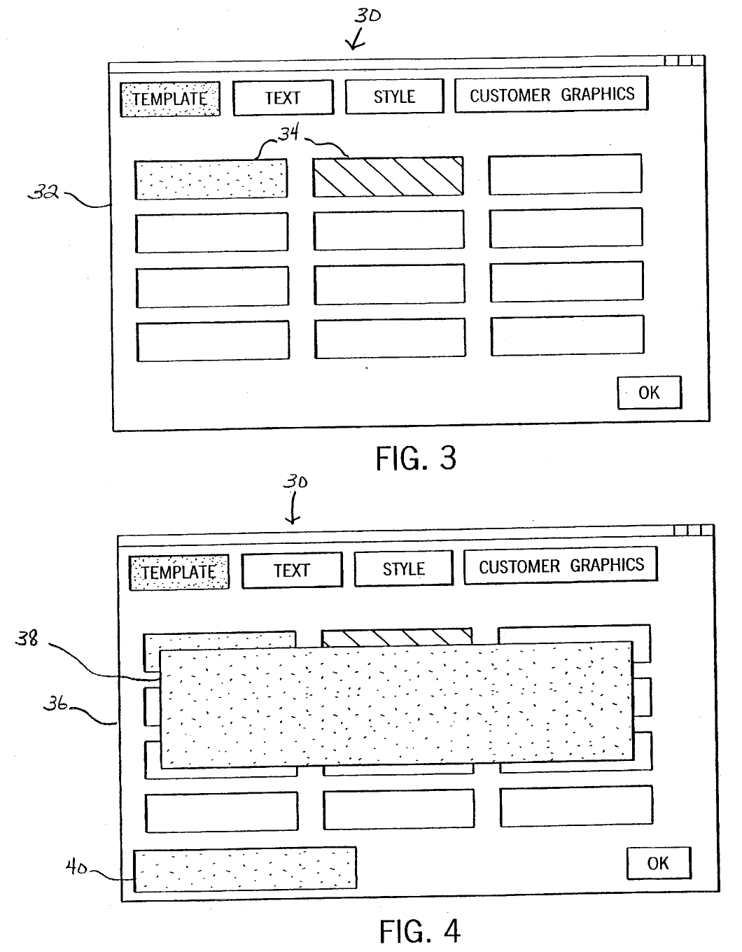

FIG. 3 is a schematic illustration of a graphic user interface (GUI) 30 showing template options display screen capture 32 having a plurality of wall border templates 34 from which a user can select. For any of the selected items in the present invention, it is contemplated that selection can be accomplished by pull-down menus, icons, thumbnail views and the like. Specifically, system 10 (FIG. 1) provides, to a user 14 (again FIG. 1), access to a plurality of wall border templates 34 from which the user can select one of the plurality of wall border templates for display at the GUI 30. Although a particular embodiment of the screen is shown, is shall be understood that many variations in the screen can be created and are within the scope of the present invention. In addition, the number, position, size, shape, and overall arrangement of, for example, particular icons, or thumbnails can be varied to convenience to adjust the screen to have a desired “look and feel”. Template 34 provides a background or “scene” that can occupy, or provide a cohesive theme, to space or regions not covered by the text or graphics (yet to be entered) and therefore form a base or starting point in the creation of the wall border for the user. Once template 34 is selected, the user can proceed in customizing the wall border further. The created wall borders can vary in height, length, and repeat based upon the template that was chosen. In addition to full color templates, additional options or backgrounds can consist of simple mono-color hue(s), high-contrast templates (e.g., black and white) similar to “coloring book” pages, or even non-modifiable “print-ready” wall borders.

FIG. 4 is a schematic illustration of GUI 30 showing template selected screen capture 36 showing a selected wall border template 38. Also shown is a precursor wall border image 40. Precursor wall border image 40 is a representation of the wall border as it is created, in essence, showing the user's selections as they occur (i.e., in “real-time”). Thus, as illustrated, precursor wall border image 40 incorporates selected wall border template 38. Precursor wall border image 40 allows the user to view the “work-in-progress” wall border without having to perform a separate preview operation in order to view, and perhaps only temporarily view, the wall border being made.

FIG. 4a is an example of one embodiment of a precursor wall border image 40. In the example illustrated, the image 40 includes a variety of stock content (e.g., a baseball bat and ball, a hockey stick and puck, etc.), which may or may not have a specific theme.

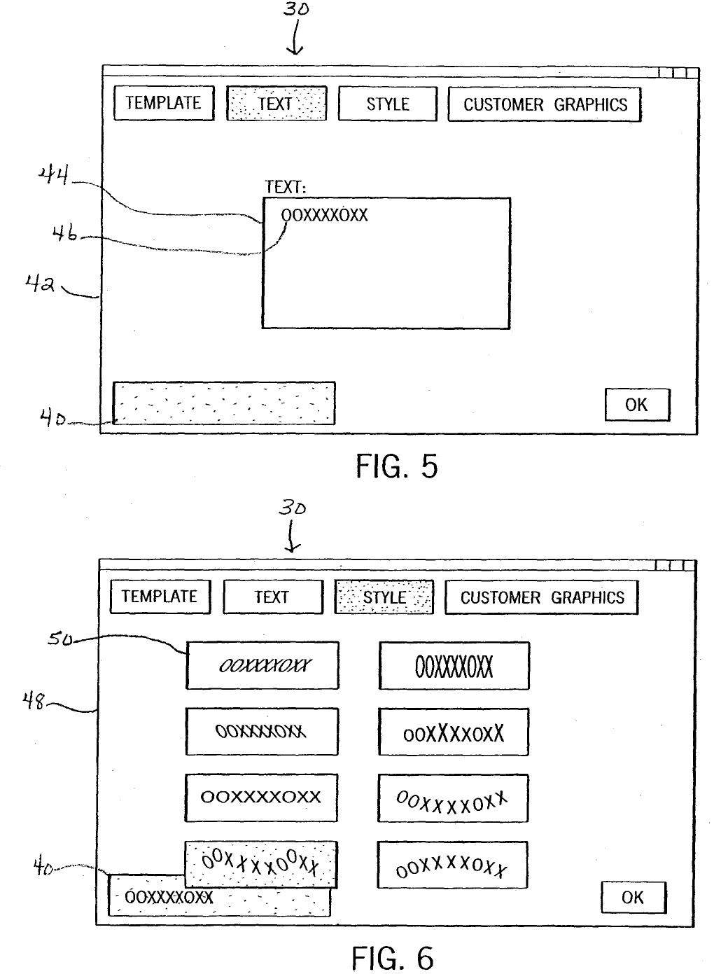

FIG. 5 is schematic illustration of GUI 30 showing user input text information screen capture 42. System 10 (FIG. 1) receives from a user 14 (again FIG. 1), user input text information 44 which is viewable at the GUI 30. Text information 44 is preferably keyboard entered by the user and represented by individual text characters 46. Text can be entered, such as via the keyboard, and as will be described, with multiple font selections. Text placement varies from template to template and can be scaled to the users preference. While the text 44 is submitted, precursor wall border image 40 is still visible and will reflect the last state of the image (i.e., prior to submission of the text). Examples of text 44 can include phrases, names, individual letters, character strings (e.g., a, b, c, . . . ), or any other text arrangements that can assist the user in customizing and personalizing the final wall border product. Text can also be copied (or cut and pasted) in using other devices, such as peripherals (e.g., mice, cats, pens, scanners, scan guns etc.) without departing from the spirit of the present invention.

FIG. 6 is schematic illustration of GUI 30 showing a customized user input text information screen capture 48. A user can select a font, character size, color or style for the text entered (as described above). Precursor wall border image 40 includes the selected template 38 (FIG. 4) and the entered text 44 (FIG. 5) and can be viewed by the user when deciding on the particular customization of the text desired. In the embodiment shown, style examples 50 of the text are shown, and include italics, angled, curved, text-character height variations, among others.

FIG. 6a is an example of the precursor wall border image 40 of FIG. 4a, but as shown, the image 40 now includes personalized text (i.e., Zach and Nate's Room). The personalized text can be located or selectively placed by the customer/user.

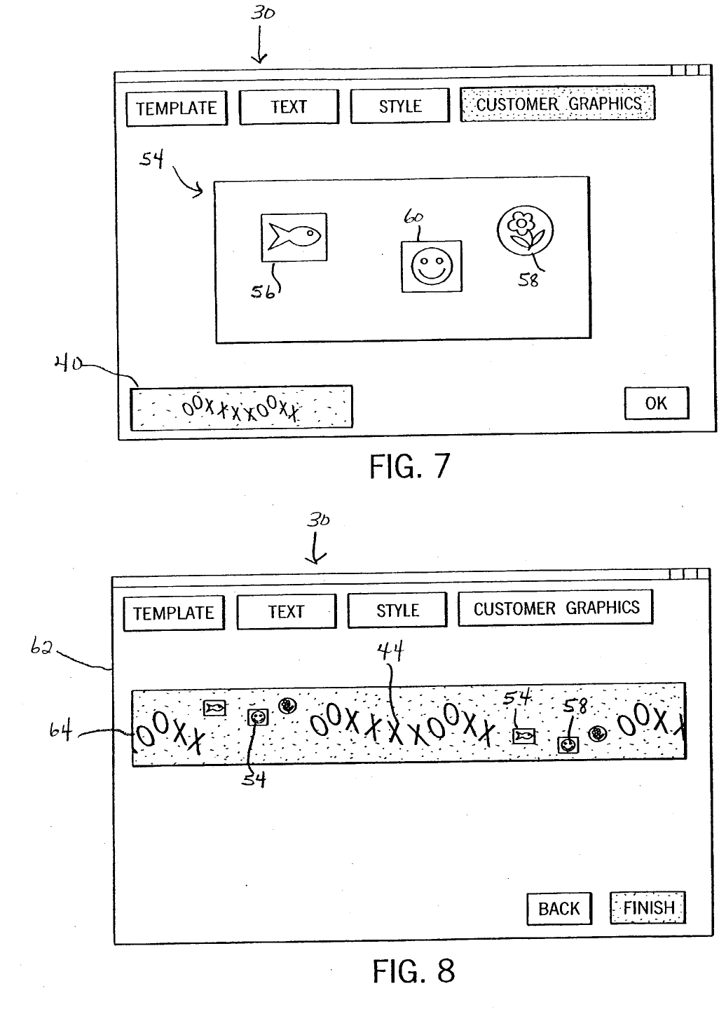

FIG. 7 is schematic illustration of a GUI 30 showing a user input graphic information screen capture 52. The user-selected graphic information 54 is received by system 10 (FIG. 1) from user 14 (FIG. 1) and viewable at the GUI 30. Graphic information 54 can comprise stock images 56 available via the GUI 30 and typically stored in database 20 (FIG. 1), uploaded digital images 58, or digital photographs 60, which are typically input by the user. Graphics can be raster and/or vector based or even a combination of the two. Graphics can take any suitable format (such as TIFF, GIF, JPEG, PDF, BMP, and the like) and may be uploaded so as to be readable by system 10. Precursor wall border image 40 is shown and includes the customized user input text information as a result of entering text 46 (FIG. 5) and customizing the text format as described in FIG. 6. The precursor wall border image can be termed a “complex thematic precursor wall border image” inn that image not only allows for user selection of a wall border theme, but inclusion and incorporation of both user input of text and graphic elements or information into the image.

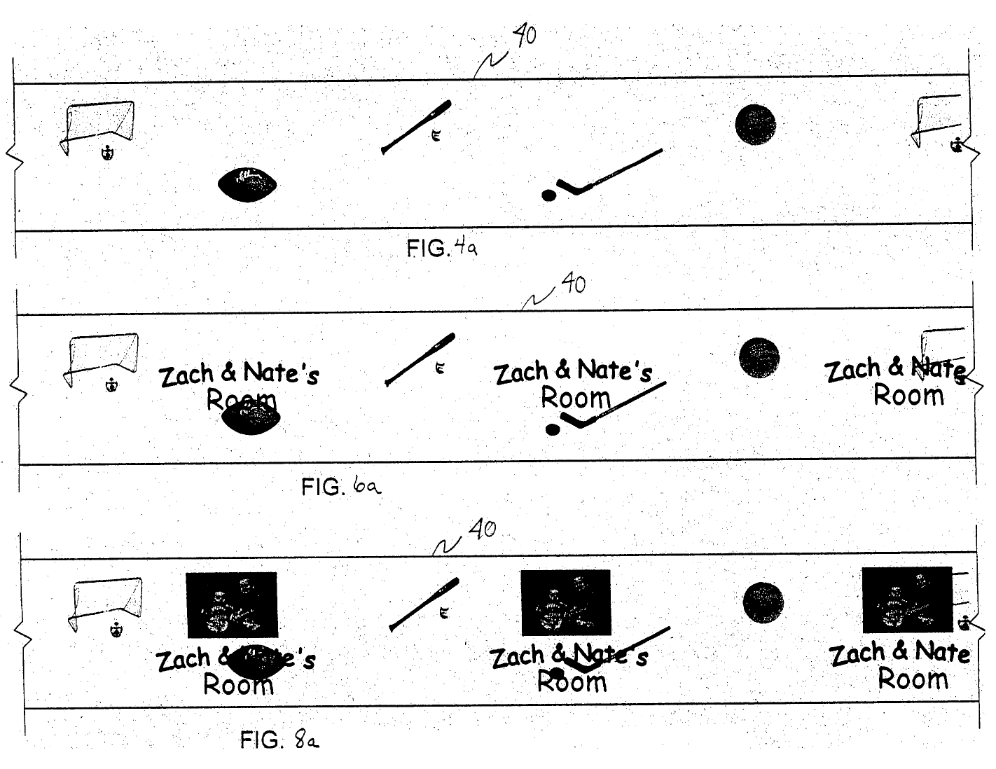

FIG. 8 is a schematic illustration of a GUI 30 with a screen capture 62 showing a dynamically-refreshable precursor wall border image 64. By “dynamic” it is meant that real time updates occur as soon as a particular template or style is selected, or text or graphic is entered, the update is previewable in the precursor wall border image and is visible at the GUI as soon as the update is complete.

The dynamically-refreshable precursor wall border image 64 is generated, in real time, to include the selected wall border template 58, the user input text information 44 and the user-selected graphic information 54. The precursor wall border image 64 is dynamically refreshable to permit changes, if any, to at least one of the selected wall border template, the user input text information and the user-selected graphic information to be incorporated into the precursor wall border image and viewable at the GUI. Functionally, the precursor wall border image 64 acts also as precursor 40 (FIGS. 4-7). To provide a more realistic simulation of the final wall border being created, the precursor image 64 includes repeated content as desired. It is important to note that both text and graphic elements can occupy the same space (that is, they can overprint or overlap) and their placement is based upon desired positions within the template selected. Variation in the order of placement is also contemplated. That is, the order in which text, graphics, and the like selected by the user can vary to convenience. For example, in some cases the text can be entered before, and in other cases after, entering or uploading graphics.

FIG. 8a is an example of the precursor wall border image 40 of FIGS. 4a and 6a, but as shown, the image 40 now includes personalized graphics (i.e., a photo of children). Here again, the personalized graphics can be located or selectively placed by the customer/user.

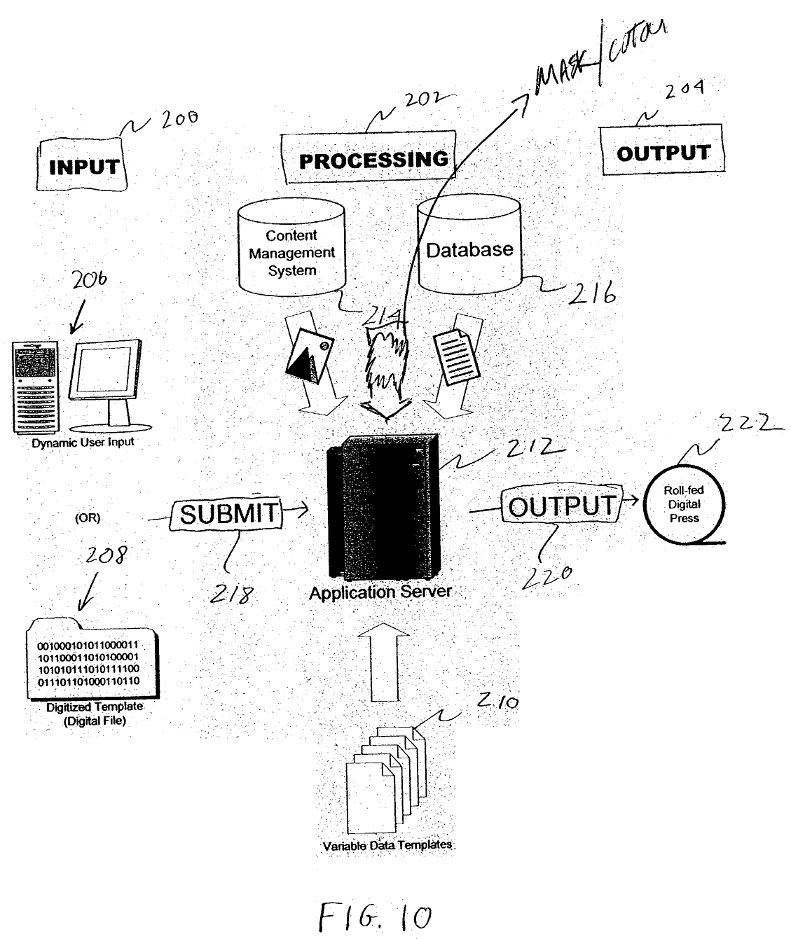

Referring to FIG. 9, an exemplary process flow chart of process 100 relating to the invention outlined above is shown. Process 100 relates generally to consumer direct (i.e., consumer purchase of wall border over the Internet) and in-store (e.g., a kiosk) purchasing avenues. In one embodiment, an introductory sales or teaser screen 102 can be displayed and in order allow employee access, a login in password 104 can be supplied to accomplish order initiation 106. The creating phase of the process includes selection of a theme 108, selection of a desired template 110, which when finished 112, a decision can be made as to whether personalized text is desired 114. If so 116, specific text is entered 118 and any font, color and style selections 120 can be made. If not 122, a decision can be made as to whether personalized imagery 124 will be incorporated the wall border, or more precisely, at this stage—the precursor wall border image. If a personalized image is desired 126, the user can select an image(s) 128, with selection resulting from, for example, online image submission, stock art or photo processing 129 (e.g., from one or more databases). In addition, a mask is selected 130. The invention permits placement of photos and application of stylized image masks. These masks provide unique clipping paths that contribute to the theme as in the child appearing to be driving a train, or holding a balloons, or the head of the child is placed on the body of a cartoon caricature. Finally, specific placement of the image(s) into the precursor wall border image can be determined 132. Once the personalized image placement is determined 132, the user can decide whether to preview 134 the precursor wall border image, and if desired 136, an onscreen preview 138 can be accomplished by the system. If a personalized image is not desired 140, again the user can proceed to preview option 134. If no preview is desired, the user can proceed to deciding whether to print a sample 142 of precursor wall border image.

As indicated in FIG. 9, onscreen previewing of the precursor wall border image occurs as a discrete step 138 in process 100. It is contemplated that, in a preferred embodiment of the invention, onscreen previewing may be continuously present (i.e., dynamically refreshable) and updated following steps 108, 112, 118, 120, 132, that is, at any time after which a selection is accomplished by the user.

If printing of a sample 142 of the precursor wall border image is desired 144, for example at a kiosk or from home personal computer, a print, preferably color, can be generated 146. If a sample is not desired 148, or after the color print is generated, an opportunity can be presented to proceed with the order, revise it, or cancel it altogether 150. If cancellation is selected 152, such cancellation is preferably confirmed 154 with the user. If revision is desired 156, the user can be returned as far back as theme selection step 108, or to a more recent step in process 100, such as template design 110, text entry 118, or image selection 128.

Proceeding 158 with the wall border order includes supplying necessary and appropriate customer/user identification information, including billing and shipping information 160, and confirming 162 whether information provided is 164, or is not 166, correct, culminating in the submission of the desired wall border 168. From the order submission, a composite print file can be generated 170, and the file can be sent to a printer along with the confirmed order information 172. At this point in process 100, the order can be printed 174, archived for any desired period of time (e.g., minutes, hours, days, etc.) 176 and ultimately shipped to the customer 178.

In another preferred embodiment, a customer can purchase a pre-packaged kit 180, from which the customer can accomplish direct (i.e., non-electronic, non-digitized format) decoration of a wall paper border, in addition to completion of necessary paperwork as prescribed in a billing form or form set 182. The customer can then submit the direct production template along with the paperwork to a production facility 184, at which the production template can be digitized 186. At this point in this embodiment, the digitized production can be printed 174, the order archived 176, and shipped 178 as described previously.

FIG. 10 illustrates several phases of the present invention, namely an input phase 200, a processing phase 202 and an output phase 204. Input phase in a web-based Internet option refers to the capture of consumer specific data such as the choice of border design/template size, including options for typeface font and/or color, graphic input, and general order data, such as required quantity of rolls and shipping and billing information. Input can be captured from any location that has access to the Internet. This would include any computer with Internet access, or alternatively, a stand alone module, such as an interactive kiosk. Typical locations for a kiosk could include retail outlets such as home improvement centers, home decorating stores, and retail/wholesale stores with decorating and/or children's departments (e.g., Toys R Us, Babies R Us, The Baby's Room, etc.). In addition to the aforementioned, an ideal location for the Input phase to occur is a photo-processing center or photography studio. Once the consumer has their film developed, or pictures chosen, they can insert their favorite photos and add text to a wall border template of their choice. Additional locations for the Input phase to occur can include dedicated ‘brick-and-mortar’ sites such as in a shopping or strip mall. These locations can preferably have numerous ‘workstations’ set-up for consumer use and can include additional amenities such as a help desk, children's activity area, and a refreshment stand. The aforementioned web-based Internet option can preferably be accomplished using a dynamic user input device 206.

The Input phase in pre-packaged kit option refers to the digitization of the “colored-in” wall border that may be submitted by a consumer along with the general wall border order data (e.g., shipping, billing, quantity information). Digitization results in a digitized template or digital file 208.

Border designs and templates can be directed to a variety of audiences and potential customers, for example, to a younger demographic or age group, or alternatively, to more mature applications, such as “Dad's Workshop”, “Mom's Kitchen”, and the like. Commercial applications include Input of company-specific information, such as the name or company logo. This would allow the production of a wall border with a corporate identity for use in a lunchroom, foyer, customer waiting area, hallway, by way of example.

Processing phase 202 refers to the compilation of consumer choices/options, the generation of a final preview sample and creation of a file for print. Also schematically illustrated is the archiving of digital content, including variable system data templates 210 and a temporary storage or ‘bank’ in application server 212 for consumer Input (e.g., graphic elements and text). Consumer information can be retained for a period of time allowing for convenient and timely reprints. The application server 212 is also in communication with content management system 214 for managing content such as graphics, and a database 216 for storing, for example, text, as well as for managing and/or storing information relating to the masking of wall border template(s). Once the order has been submitted 218 and confirmed, the system can merge the chosen template and personalized consumer data to generate an output 220, such as a print file. The system can automatically send the file with all pertinent order information to a predetermined print location (again, for example at a remote production facility). The file(s) can then remain in cue at the print location awaiting final output.

The output phase 204 refers to digital print production of a file that was generated from a consumer-chosen template merged with customized text and/or graphics onto a pre-pasted wall border substrate, pressure-sensitive, or other self-adhering wall border substrate. The substrate itself is preferably made from a readily available material, such as paper or synthetic paper, or plastic, metal, glass or wood. Printing methodologies contemplated for use in the present invention include a roll-to-roll (i.e., roll-fed) digital press 222 that utilizes toner-based inks and prints to a continues web of substrate material. Additional benefits from this equipment are increased print quality through ‘computer-to-press’ technology and significantly, the capability of accommodating variable data that is Input by the customer. Ideally, the printing system will work with any color-imaging device capable of roll-fed material and variable data that has been Input.

Post-print, there are additional finishing procedures. For example, in the Input phase, the consumer can choose a desired gloss level (e.g., dull/matte, semi-gloss, hi-gloss, etc.). After printing is complete, the appropriate coating is applied. The rolls can then be ‘slit’ to final size or even die-cut (per consumer Input), re-wound to a predetermined length, and shipped via appropriate means to the consumer. Post print processes permit creation and delivery of a ‘consumer-ready’ product (i.e., a product that does not require excessive additional finishing operations, such as trimming and/or cutting. Minimal cutting at logical border termination points, however, can be expected).

The methods described above can be accomplished by a variety of physical means performing the functions of the above steps., including any Internet websites, and may be employed in systems having a multitude of functionalities. For example, the invention can be embodied by the following systems:

A system for creating a dynamically-customizable wall border file, the system comprising an application server for receiving customized graphic and text input data; a content management system for managing wall border file data; and a database for storing the stock wall border data;

A system for creating a dynamically-customizable wall border, the system comprising an application server for receiving customized wall border data; a database for providing template wall border data; and a content management system for managing the customized wall border data and the template wall border data and finishing the wall border to create a consumer ready wall border product, where the consumer ready product is a product that does not require further operations including at least one of trimming, cutting, coating to a user-desired gloss level.

An interactive system for on-screen development of a wall-border preview comprising a computerized wall border preview comprising a template selected from a plurality of stock templates; customized text repeatedly positioned along the template; customized uploaded images repeatedly positioned along the template; wherein the computerized wall border preview may be used to create a wall border; and

A wall border creation computer website comprising graphical displays of sample wall border designs; graphical displays of input customized text; graphical displays of customized uploaded images; wherein the website permits graphic combination and display of at least one of the sample wall border designs, the input customized text, and the customized uploaded images.

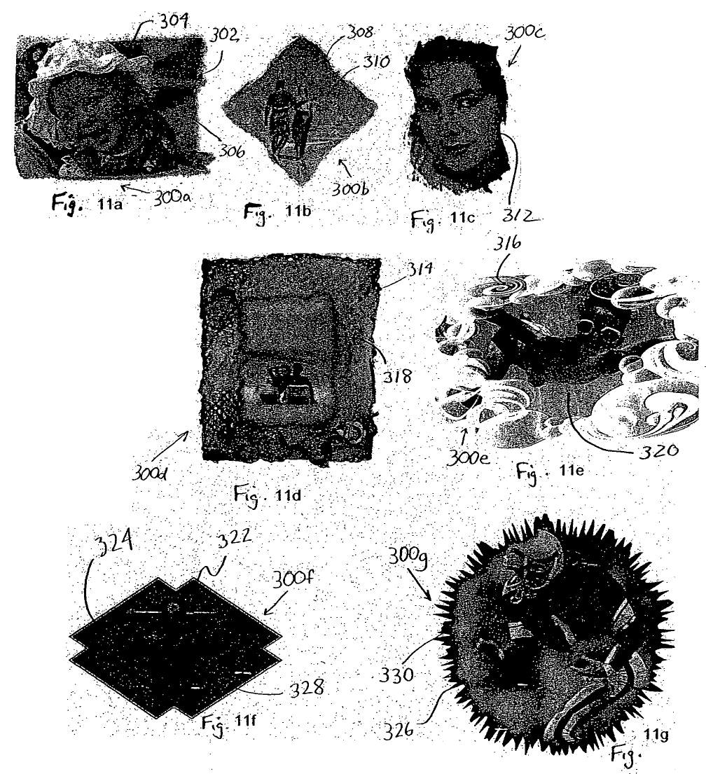

FIGS. 11a-g illustrate masked images 300a-g utilizing image masks used as part of one aspect of the present invention. An exemplary procedure contemplated includes the user uploading or otherwise transmitting the graphic user information (e.g., an image) to the website, kiosk, etc. Once the image is entered into the system, the image is moved, for example, by copying and pasting, dragging and dropping, for example via a keyboard or a peripheral device such as a mouse, within the template selected as part of the wall border creation process. Once the image is entered into the template, the system, in part based on the amount of space available within the template for an image and on the selected preferences of the user, masks the image to clip, cut, soften, zoom in, zoom out, scale, edge fade-out, or otherwise conducts any related graphics processing activity that gives the desired visual effect to the image and/or to the border edge of the image. The edge of the input image need not be limited to hard edges, but can be softened, curved or otherwise stylized to create dramatic effects. As illustrated in FIG. 11a, portions of the edge 302 are removed while maintaining the subject 304 of the image 306, and parts of the edge 302 are pixeled out to introduce, for example, a “worn” edge and “shadowed” look. In FIG. 11b, the frame of the image 310 is masked to produce a diamond frame with the edges 308 partially erased to give a wave impression, similar to the message conveyed in image 310. In FIG. 11c, the subject 312 of the image is focused upon by eliminating all background, and partially removing the portions of the area around the face to produce a dramatic result. Accordingly, as a result of the examples of FIGS. 11a-c, the modified wall border template includes a graphical image that is masked to fit into the wall border template, to remove any unwanted portion of the image, and to contain or retain desired visual effects.

In other words, the user is able to place their image in position on the wall border within a predetermined space (i.e., per the chosen template) and in doing so the system automatically clips-out any undesired image, such as the background or non-focal subjects.

It is contemplated that, in addition to the masking the background of the wall border template, the stylized mask can take on a different design from the template, so as to “frame” the image. Although any type of mask is contemplated, in an exemplary embodiment, the masking can take on thematic similarities to the image, or to the template, so as to convey a specific graphic impression. The mask acts as a frame for the image and complements the design of the wall border itself. The stylized image mask is a predetermined clipping path or cut-out pattern that facilitates the integration of user supplied images into the wall border template. The image, once placed, is automatically cut-to-fit within the window of the frame. The user can scale the image so that it fits within the mask window proportionately. In an exemplary fashion, FIGS. 11d-e show thematic masking frames 314, 316 within which images 318, 320 are embedded. The beach and water themes of the images 318, 320 are highlighted by the use of the stylized or thematic image masking frames 314, 316. Moreover, in FIGS. 11f-g, geometric effects, including sharp double lines 322, shapes 324, and jagged edges 326 are used, in the cases shown, to convey a message of strength and high energy, the effects of which are heightened through the use of the framing stylized masks 300f-g with the wall border images 328, 330. One masking software that is suitable for use in the present invention is Photo/Graphic Edges, available from Auto F/X, located in Alton Bay, N.H., (www.autofx.com).

Generally, methods have been described and outlined in a sequential fashion. Still, modification, rearrangement, combination, reordering, or the like, of the methods is contemplated and considered within the scope of the appending claims.

The present invention has been described in terms of preferred embodiments, and it is recognized that equivalents, alternatives, and modifications, aside from those expressly stated, are possible and within the scope of the appending claims.

What is claimed is:

1. A method for creating a dynamically-customizable precursor wall border image for display on a graphic user interface (GUI), or a digital or electronic device, and capable of use in creating a wall border, the method comprising:
providing, to a user, access to a plurality of wall border templates from which a user can select one of the plurality of wall border templates for display at the GUI;
receiving user input text information, the user input text information viewable at the GUI;
receiving user-selected graphic information, the user-selected graphic information viewable at the GUI; and
generating, in real time, a precursor wall border image at the GUI, the precursor wall border image having the selected wall border template, the user input text information and the user-selected graphic information;
wherein the precursor wall border image is dynamically refreshable to permit changes, if any, to at least one of the selected wall border template, the user input text information and the user-selected graphic information to be incorporated into the precursor wall border image and viewable at the GUI in real time by the user.

2. The method of claim 1 further comprising permitting selective placement of the user input graphic information into any location on the selected wall border template.

3. The method claim 1 wherein the precursor wall border image is a complex thematic precursor wall border image.

4. A method for creating a dynamically-customizable wall border, the method comprising:
providing, to a user, access to a plurality of wall border templates from which a user can select one of the plurality of wall border templates for display at a graphic user interface (GUI);
receiving user input text information, the user input text information viewable at the GUI;
receiving user input graphic information, the user input graphic information viewable at the GUI; and
generating, in real time, a precursor wall border image at the GUI, the precursor wall border image having the selected wall border template, the user input text information and the user input graphic information; and
printing a wall border using the precursor wall border image;
wherein the precursor wall border image is dynamically refreshable to permit changes, if any, to at least one of the selected wall border template, the user input text information and the user input graphic information to be incorporated into the precursor wall border image and viewable at the GUI in real time by the user.

5. The method of claim 4 further wherein the precursor wall border image is a complex thematic precursor wall border image.

6. The method of claim 4 further comprising permitting selective placement of the user input graphic information into any location on the selected wall border template.

7. The method of claim 4 wherein the printing occurs on at least one of: a roll-fed press, a computer-to-plate press, variable data input printer

8. The method of claim 4 wherein printing includes printing to a pressure-sensitive or other self-adhering wall border substrate.

9. A system for creating a dynamically-customizable precursor wall border image for display on a graphic user interface (GUI) and capable of use in creating a wall border, the system comprising:
means for providing, to a user, access to a plurality of wall border templates from which a user can select one of the plurality of wall border templates for display at the GUI;
means for receiving user input text information, the user input text information viewable at the GUI;
means for receiving user input graphic information, the user input graphic information viewable at the GUI; and
means for generating, in real time, a precursor wall border image at the GUI, the precursor wall border image having the selected wall border template, the user input text information and the user input graphic information;
wherein the precursor wall border image is dynamically refreshable to permit changes, if any, to at least one of the selected wall border template, the user input text information and the user input graphic information to be incorporated into the precursor wall border image and viewable at the GUI in real time by the user.

10. The system of claim 9 further comprising means for permitting selective placement of the user input graphic information into any location on the selected wall border template.

11. The system of claim 9 wherein the precursor wall border image is a complex thematic precursor wall border image.

12. A system for creating a dynamically-customizable wall border, the system comprising:
means for providing, to a user, access to a plurality of wall border templates from which a user can select one of the plurality of wall border templates for display at a graphic user interface (GUI);
means for receiving user input text information, the user input text information viewable at the GUI;
means for receiving user input graphic information, the user input graphic information viewable at the GUI; and
means for generating, in real time, a precursor wall border image at the GUI, the precursor wall border image having the selected wall border template, the user input text information and the user input graphic information; and
means for printing a wall border using the precursor wall border image;
wherein the precursor wall border image is dynamically refreshable to permit changes, if any, to at least one of the selected wall border template, the user input text information and the user input graphic information to be incorporated into the precursor wall border image and viewable at the GUI in real time by the user.

13. The method of claim 12 further wherein the precursor wall border image is a complex thematic precursor wall border image.

14. The system of claim 12 further comprising means for permitting selective placement of the user input graphic information into any location on the selected wall border template.

15. The system of claim 4 wherein the means for printing includes on at least one of: a roll-fed press, a computer-to-plate press, variable data input printer.

16. The system of claim 12 wherein the user input graphic information includes a digital photograph.

17. The system of claim 12 wherein the wall border precursor image is stored into a wall border and wherein the wall border file is used to create a wall border network.

18. The system of claim 12 wherein the GUI is on a computer that is a part of a global computer network.

19. The system of claim 12 wherein the global computer network is the Internet

20. The method of claim 1 wherein the method includes providing selection of font, color and style, of the user input text information.

21. A wall border made by the method of claim 1.

22. The method of claim 1 further including masking the user-selected graphic information to create a stylized image mask.

23. The method of claim 22 wherein the masking includes clipping the user-selected graphic information, thereby eliminating at least portion of the user-selected graphic information, in creating the stylized image mask.

24. The method of claim 22 framing the stylized image mask to create a framed stylized image mask.
